(19) United States
(12) Patent Application Publication
(10) Pub. No.: US 2026/0175385 A1
(43) Pub. Date: Jun. 25, 2026

(54) POWERED FASTENER DRIVER

(71) Applicant: MILWAUKEE ELECTRIC TOOL CORPORATION, Brookfield, WI (US)

(72) Inventors: Joseph A. Jurss, Port Washington, WI (US); Alex G. Bournoville, New Berlin, WI (US); David M. Pittman, Sussex, WI (US); Marcus M. Wechselberger, Milwaukee, WI (US); Jacob N. Nemec, Waldo, WI (US); David C. Graf, Greendale, WI (US)

(21) Appl. No.: 19/426,930

(22) Filed: Dec. 19, 2025

Related U.S. Application Data
(60) Provisional application No. 63/737,040, filed on Dec. 20, 2024.

(51) Int. Cl. B25C 1/04; B25C 1/06

(52) U.S. Cl. CPC B25C 1/047; B25C 1/06

(57) ABSTRACT

A powered fastener driver includes a housing, a cylinder within the housing that has an outer shell formed from a first material, and an inner sleeve at least partially located within the outer shell that is formed from a different, second material. The fastener driver also includes a piston movable within the cylinder from a top-dead-center (TDC) position to a driven or bottom-dead-center (BDC) position, and a driver blade coupled for movement with the piston between the TDC position and the BDC position during a fastener driving operation.

### CROSS-REFERENCE TO RELATED APPLICATIONS

This application claims priority to U.S. Provisional Patent Application No. 63/737,040 filed on Dec. 20, 2024, the entire content of which is incorporated herein by reference.

### FIELD OF THE INVENTION

The present invention relates to powered fastener drivers, and more particularly to gas spring fastener drivers.

### BACKGROUND OF THE INVENTION

There are various fastener drivers known in the art for driving fasteners (e.g., nails, tacks, staples, etc.) into a workpiece. These fastener drivers operate utilizing various means known in the art (e.g. compressed air generated by an air compressor, electrical energy, a flywheel mechanism, etc.), but often these designs are met with power, size, and cost constraints.

### SUMMARY OF THE INVENTION

The present invention provides, in one aspect, a powered fastener driver including a housing, a cylinder within the housing having an outer shell formed from a first material, and an inner sleeve at least partially located within the outer shell that is formed from a different, second material. The powered fastener driver further includes a piston movable within the cylinder from a top-dead-center (TDC) position to a driven or bottom-dead-center (BDC) position, and a driver blade coupled for movement with the piston between the TDC position and the BDC position during a fastener driving operation.

The present invention provides, in another aspect, a powered fastener driver including a housing, an inner cylinder having an outer shell formed from a first material, and an inner sleeve at least partially located within the outer shell that is formed from a different, second material. The powered fastener driver further includes a storage chamber cylinder at least partially surrounding the inner cylinder having a pressurized gas in fluid communication with the inner cylinder, a piston movable within the inner cylinder from a top-dead-center (TDC) position to a driven or bottom-dead-center (BDC) position, and a driver blade coupled for movement with the piston between the TDC position and the BDC position during a fastener driving operation.

The present invention provides, in yet another aspect, a powered fastener driver including a housing, a cylinder within the housing having an outer shell formed from a first material, and an inner sleeve at least partially located within the outer shell formed from the first material, a piston movable within the cylinder from a top-dead-center (TDC) position to a driven or bottom-dead-center (BDC) position, and a driver blade coupled for movement with the piston between the TDC position and the BDC position during a fastener driving operation.

Other features and aspects of the invention will become apparent by consideration of the following detailed description and accompanying drawings.

### BRIEF DESCRIPTION OF THE DRAWINGS

FIG. 1A is a side view of a powered fastener driver in accordance with an embodiment of the invention.

FIG. 1B is another side view of the powered fastener driver of FIG. 1A, with portions of a housing of the powered fastener driver of FIG. 1A removed.

FIG. 2 is a cross-sectional view of the powered fastener driver of FIG. 1A, illustrating a cylinder assembly including an inner cylinder within which a driver piston and blade reciprocate and an outer storage chamber cylinder in which compressed gas is stored.

FIG. 3 is a is a cross-sectional view of another embodiment of a cylinder assembly for use with the powered fastener driver of FIG. 1A.

FIG. 4 is a cross-sectional view of another embodiment of an inner cylinder for use with the powered fastener driver of FIG. 1A.

FIG. 5 is a cross-sectional view of another embodiment of an inner cylinder for use with the cylinder assembly of FIG. 3.

FIG. 6 is a cross-sectional view of another embodiment of an inner cylinder for use with the cylinder assembly of FIG. 3.

FIG. 7 is a cross-sectional view of another embodiment of an inner cylinder for use with the cylinder assembly of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

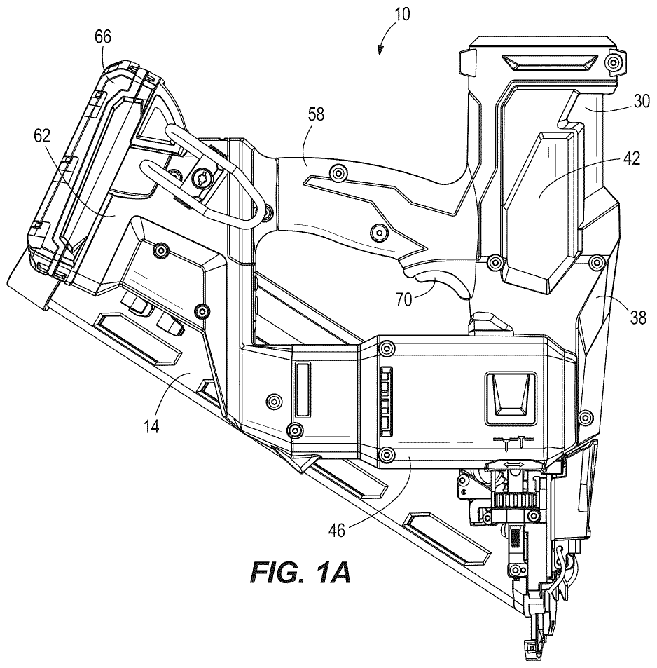

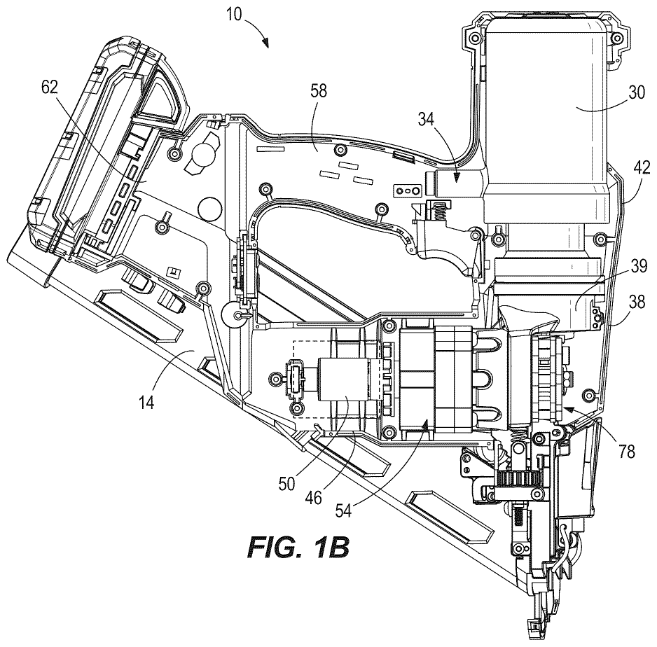

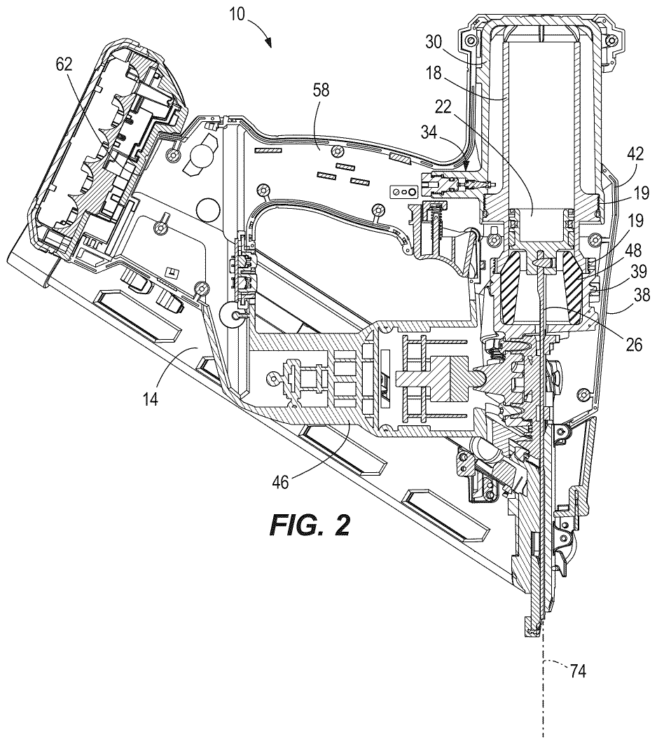

With reference to FIGS. 1A-2, powered fastener driver 10 is operable to drive fasteners (e.g., nails, tacks, staples, etc.) held within a magazine 14 into a workpiece. The fastener driver 10 includes an inner cylinder 18 and a moveable piston 22 positioned within the cylinder 18 (FIG. 2). The fastener driver 10 further includes a driver blade 26 that is attached to the piston 22 and moveable therewith and an elastomeric bumper 48 (FIG. 2) supported by the inner cylinder 18 and configured to absorb the kinetic energy of the piston 22 during operation of the fastener driver 10. The fastener driver 10 does not require an external source of air pressure, but rather includes an outer storage chamber cylinder 30 of pressurized gas in fluid communication with the inner cylinder 18. In the illustrated embodiment, the inner cylinder 18 and moveable piston 22 are positioned within the storage chamber cylinder 30. With reference to FIG. 1B, the driver 10 further includes a fill valve 34 coupled to the storage chamber cylinder 30. When connected with a source of compressed gas, the fill valve 34 permits the storage chamber cylinder 30 to be refilled with compressed gas if any prior leakage has occurred. The fill valve 34 may be configured as a Schrader valve, for example.

With reference to FIGS. 1A-1B, the fastener driver 10 includes a housing 38 having a cylinder housing portion 42 and a motor housing portion 46 extending therefrom. The cylinder housing portion 42 is configured to support the cylinders 18, 30, whereas the motor housing portion 46 is configured to support a motor 50 and a transmission 54 operatively coupled to the motor 50. The illustrated transmission 54 is configured as a planetary transmission having three planetary stages. In alternative embodiments, the transmission 54 may be a single-stage planetary transmission, or a multi-stage planetary transmission including any number of planetary stages.

The housing 38 further includes a handle portion 58 extending from the cylinder housing portion 42, and a battery attachment portion 62 coupled to an opposite end of the handle portion 58. A battery 66 (FIG. 1A) is electrically connectable to the motor 50 for supplying electrical power to the motor 50. The handle portion 58 supports a trigger 70, which is depressed by a user to initiate a firing cycle of the fastener driver 10.

With reference to FIG. 2, the inner cylinder 18 and the driver blade 26 define a longitudinal (or “driving”) axis 74. During a firing cycle, the driver blade 26 and piston 22 are moveable between a top-dead-center (TDC) position and a driven or bottom-dead-center (BDC) position. The fastener driver 10 further includes a lifting assembly 78 (FIG. 1B), which is powered by the motor 50, and which is operable to move the driver blade 26 from the BDC position toward the TDC position.

With reference to FIGS. 1B and 2, the fastener driver 10 includes a frame 39 to which the inner cylinder 18 is coupled. In the illustrated embodiment, the inner cylinder 18 includes external threads 19 engaged with corresponding internal threads on the frame 39, and the outer storage chamber cylinder 30 includes internal threads engaged with corresponding external threads 19 on the inner cylinder 18.

In operation, the lifting assembly 78 drives the piston 22 and the driver blade 26 toward the TDC position by energizing the motor 50. As the piston 22 and the driver blade 26 are driven toward the TDC position, the gas above the piston 22 is compressed. Prior to reaching the TDC position, the motor 50 is deactivated and the piston 22 and the driver blade 26 are held in a ready position, which is located between the TDC and the BDC positions. Upon user depression of the trigger 70 (FIG. 1A), the lifting assembly 78 continues lifting of the driver blade 26 from the ready position to the TDC position where the driver blade 26 is released from the lifting assembly 78. When released, the compressed gas above the piston 22 and within the storage chamber cylinder 30 drives the piston 22 and the driver blade 26 to the BDC position, thereby driving a fastener into the workpiece. The illustrated fastener driver 10 therefore operates on a gas spring principle utilizing the lifting assembly 78 and the piston 22 to compress the gas within the inner cylinder 18 and the storage chamber cylinder 30.

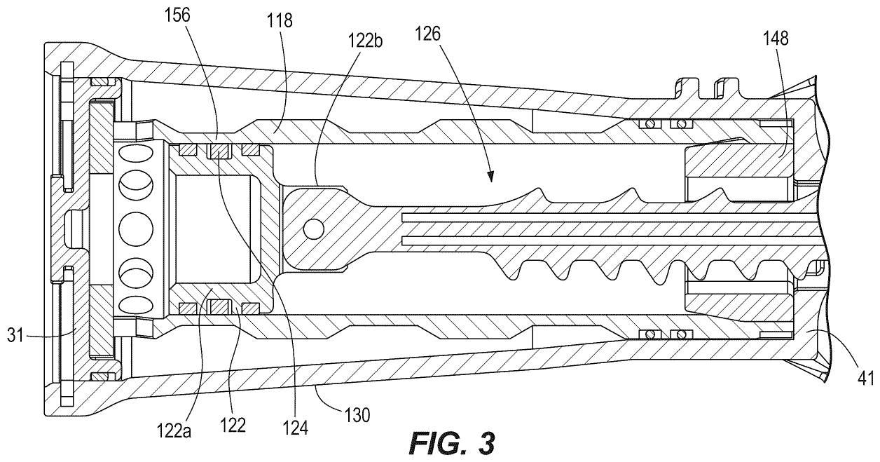

FIG. 3 illustrates an alternative embodiment of an inner cylinder 118 for use with the powered fastener driver 10 of FIGS. 1A-2 instead of the inner cylinder 18. Like components and features to the fastener driver 10 will be used plus “100”.

With reference to FIG. 3, the piston 122 includes a first portion 122a and a second portion 122b that is integrally formed with or otherwise coupled to the first portion 122a. The first portion 122a defines a groove 124 (e.g., a circumferential groove) that extends about a circumference thereof. The second portion 122b is coupled to the driver blade 126. In the illustrated embodiment, the second portion 122b is integrally formed with the first portion 122a. In some embodiments, the second portion 122b may be coupled to the first portion 122a via threaded engagement or via a fastener. In the illustrated embodiment, the driver blade 126 is coupled to the piston 122 via a fastener (e.g., a pin), but in other embodiments, the driver blade 126 may be coupled to the piston 122 via a threaded engagement.

In the illustrated embodiment, the groove 124 of the first portion 122a receives a seal ring 156 therein, which seals the piston 122 relative to the inner cylinder 118. In some embodiments, the seal ring 156 is configured as a “quad ring.” In other embodiments, the seal ring 156 may be an O-ring having a conventional cylindrical cross-section. Regardless of whether the seal ring 156 is a quad ring or an O-ring, the seal ring 156 is made from an elastomer or plastic material having a material composition to reduce friction with the inner wall of the inner cylinder 118 during sliding contact therewith.

With yet continued reference to FIG. 3, the inner cylinder 118 is configured to guide the piston 122 and the driver blade 126 along the driving axis 74 (FIG. 2) to compress the gas in a storage chamber cylinder 130. The inner cylinder 118 is therefore sized and shaped according to the size and shape of the piston 122. In the illustrated embodiment, the storage chamber cylinder 130 surrounds the inner cylinder 118, which is clamped between an upper wall 41 of the frame 39 (FIG. 2) and an end cap 31 affixed to the distal end of the outer storage chamber cylinder 130. Also, as shown in FIG. 3, the storage chamber cylinder 130 is integrally formed with the frame 39 as a single piece.

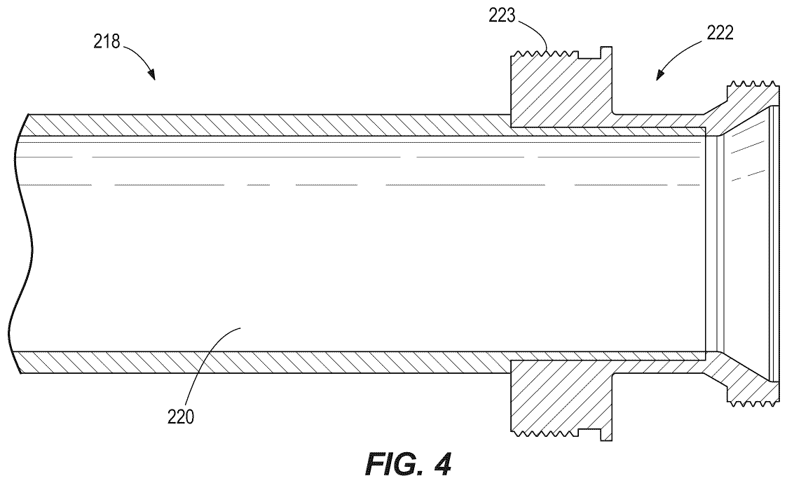

FIG. 4 illustrates an alternative embodiment of an inner cylinder 218 that can be used instead of the inner cylinder 18 in the powered fastener driver 10 of FIG. 2. The inner cylinder 218 includes a first tubular portion 220 fabricated from an extruded Aluminum material and press-fit onto a lower body portion 222 that is made from Aluminum with a die-casting process. The lower body portion 222 includes a threaded portion 223 for threadably coupling to the outer storage chamber cylinder 30 (FIG. 1B).

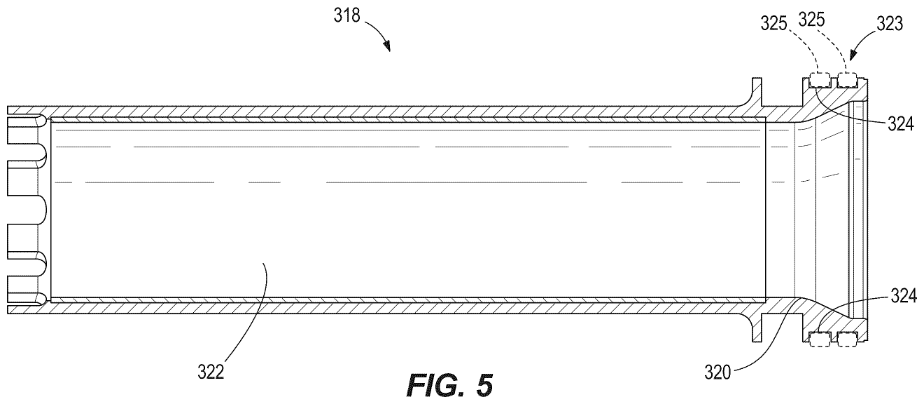

FIG. 5 illustrates an alterative embodiment of an inner cylinder 318 that can be used instead of the inner cylinder 118 of FIG. 3. The inner cylinder 318 includes an outer shell 320 formed from a plastic material and an Aluminum inner sleeve 322 located within the outer shell 320. The Aluminum inner sleeve 322 provides a better sealing surface for the piston 22 (FIG. 2) and added durability. The inner cylinder 318 further includes a sealing surface 323 having a plurality of annular grooves 324 located on the outer shell 320 that receive one or more O-rings 325 for sealing the inner cylinder 318 to the storage chamber cylinder 30 (FIG. 3). For example, this type of sealing relationship creates a seal between the inner cylinder 318 and the outer storage chamber cylinder 30. In some embodiments of the inner cylinder 318, the annular grooves 324 are configured to receive sealing material (e.g., rubber) that is co-molded with the outer shell 320. In other embodiments of the inner cylinder 318, the annular grooves 324 can be a singular annular groove 324 configured to receive sealing material that is co-molded with the outer shell 320.

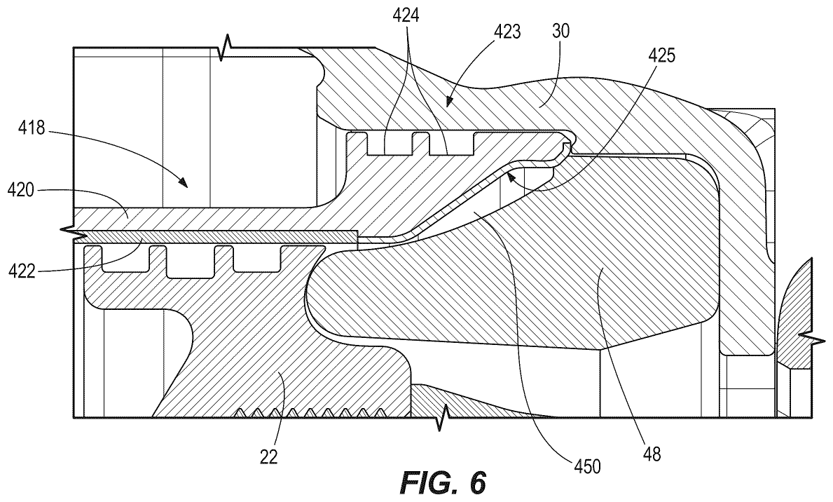

FIG. 6 illustrates an alternative embodiment of an inner cylinder 418 that can be used instead of the inner cylinder 118 of FIG. 3. Like components and features to the inner cylinder 318 will be used plus “100”. The inner cylinder 418 includes an outer shell 420 formed from a plastic material and an Aluminum inner sleeve 422 located within the outer shell 420. The outer shell 420 includes a sealing surface 423 having a plurality of annular grooves 424 located on the outer shell 420 that receive one or more O-rings (not shown) for sealing the inner cylinder 418 and the storage chamber cylinder 30. For example, this type of sealing relationship creates a seal between the inner cylinder 418 and the outer storage chamber cylinder 30. The inner cylinder 418 further includes a carbon fiber insert 425 positioned in an annular space 450 located between the outer shell 420 and the bumper 48 (FIG. 2) to strengthen the inner portion of the inner cylinder 418 as the bumper 48 is compressed from being impacted by the piston 22. In other embodiments, the carbon fiber insert 425 can be comprised of other materials, such as glass fiber, metallic wire, and nylon or aramid threads that are wound roughly tangentially and embedded/co-molded/laid-up with a polymer material. In yet other embodiments, the carbon fiber insert 425 can be insert molded within the outer shell 420.

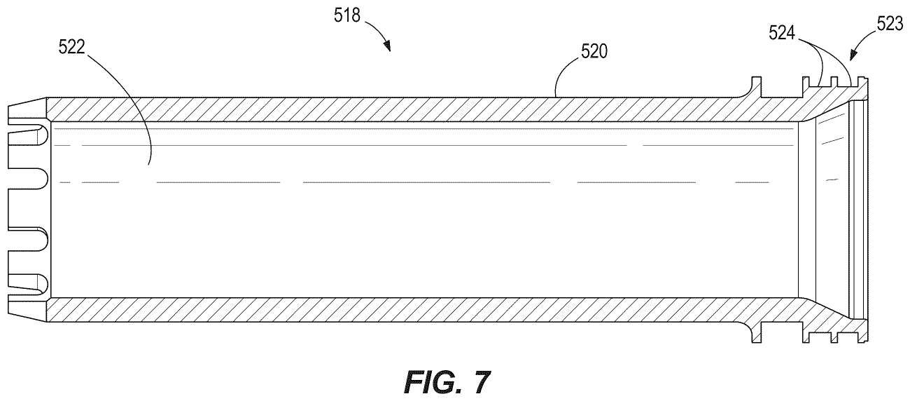

FIG. 7 illustrates an alternative embodiment of an inner cylinder 518 that can be used instead of the inner cylinder 118 of FIG. 3. Like components and features to the inner cylinder 318 will be used plus “200”. The inner cylinder 518 includes an outer shell 520 formed from a plastic material and an inner sleeve 522 also formed of a plastic material. The inner cylinder 518 further includes a sealing surface 523 having a plurality of annular grooves 524 located on the outer shell 320 that receives one or more O-rings (not shown) for sealing the inner cylinder 518 to the storage chamber cylinder 30 (FIG. 1B). For example, this type of sealing relationship creates a seal between the inner cylinder 518 and the outer storage chamber cylinder 30. In some embodiments of the inner cylinder 518, the outer shell 520 and/or the inner sleeve 522 can be coated with a surface coating (not shown) to improve the seal surface between the outer storage chamber cylinder 30 and the outer shell 520, and the piston 22 and the inner sleeve 522. In other embodiments of the inner cylinder 518, the surface coating on the outer shell 520 can replace the plurality of O-rings disposed in the annular grooves 524 and the surface coating can be formed of a different material than the inner cylinder 518. In yet other embodiments, the inner cylinder 518 is a single piece including the surface coating to improve the seal surface between the outer storage chamber cylinder 30 and the inner cylinder 518, and the piston 22 and the inner cylinder 518.

By allowing for the substitution of the inner cylinders 18, 118 of the powered fastener driver 10 with any of the other alternative embodiments of the inner cylinders 218, 318, 418, 518, a user can optimize the performance of the driver 10. For example, the user can select one of the inner cylinders 218, 318, 418, 518 for its particular material properties so, for instance, the user can reduce the weight of the driver 10 and/or increase the seal formed between the inner cylinders 218, 318, 418, 518 and the outer storage chamber cylinder 30 and/or the piston 22. Furthermore, any of the embodiments of the inner cylinders 218, 318, 418, 518 can be used in other power tools, such as rotary hammers.

Although the invention has been described in detail with reference to certain preferred embodiments, variations and modifications exist within the scope and spirit of one or more independent aspects of the invention as described.

Various features of the invention are set forth in the following claims.

What is claimed is:

1. A powered fastener driver comprising:
a housing;
a cylinder within the housing and including
an outer shell formed from a first material, and
an inner sleeve at least partially located within the outer shell, the inner sleeve formed from a different, second material;
a piston movable within the cylinder from a top-dead-center (TDC) position to a driven or bottom-dead-center (BDC) position; and
a driver blade coupled for movement with the piston between the TDC position and the BDC position during a fastener driving operation.

2. The powered fastener driver of claim 1, wherein the outer shell is formed from a plastic material.

3. The powered fastener driver of claim 2, wherein the inner sleeve is formed from a metal.

4. The powered fastener driver of claim 3, wherein the inner sleeve is insert molded with the outer sleeve.

5. The powered fastener driver of claim 1, wherein the cylinder further comprises a composite insert positioned within the outer shell adjacent a distal end of the inner sleeve.

6. The powered fastener driver of claim 5, further comprising a bumper at least partially positioned within the inner cylinder and configured to stop the piston at the BDC position, wherein the composite insert is positioned within an annular space located between the outer shell and the bumper.

7. The powered fastener driver of claim 1, further comprising a seal co-molded with the cylinder and formed from a third material, different from the first material and the second material.

8. The powered fastener driver of claim 1, wherein the outer shell further comprises
a plurality of annular grooves, and
a plurality of seals, each one of the seals is disposed in one of the annular grooves.

9. A powered fastener driver comprising:
a housing;
an inner cylinder including
an outer shell formed from a first material, and
an inner sleeve at least partially located within the outer shell, the inner sleeve formed from a different, second material;
a storage chamber cylinder at least partially surrounding the inner cylinder, the storage chamber cylinder including a pressurized gas in fluid communication with the inner cylinder;
a piston movable within the inner cylinder from a top-dead-center (TDC) position to a driven or bottom-dead-center (BDC) position; and
a driver blade coupled for movement with the piston between the TDC position and the BDC position during a fastener driving operation.

10. The powered fastener driver of claim 9, further comprising a frame coupled to the inner cylinder, wherein the storage chamber cylinder is integrated into the frame.

11. The powered fastener driver of claim 9, wherein the outer shell is formed from a plastic material.

12. The powered fastener driver of claim 11, wherein the inner sleeve is formed from a metal.

13. The powered fastener driver of claim 9, wherein the cylinder further comprises a composite insert positioned within the outer shell adjacent a distal end of the inner sleeve.

14. The powered fastener driver of claim 13, further comprising a bumper at least partially positioned within the inner cylinder and configured to stop the piston at the BDC position, wherein the composite insert is positioned within an annular space located between the outer shell and the bumper.

15. The powered fastener driver of claim 9, further comprising:
an annular groove; and
a seal disposed within the groove and configured to create a seal between the inner cylinder and the storage chamber cylinder.

16. A powered fastener driver comprising:
a housing;
a cylinder within the housing and including
an outer shell formed from a first material, and
an inner sleeve at least partially located within the outer shell formed from the first material;
a piston movable within the cylinder from a top-dead-center (TDC) position to a driven or bottom-dead-center (BDC) position; and
a driver blade coupled for movement with the piston between the TDC position and the BDC position during a fastener driving operation.

17. The powered fastener driver of claim 16, wherein the first material is a plastic.

18. The powered fastener driver of claim 16, wherein the first material is a metal.

19. The powered fastener driver of claim 16, wherein the inner sleeve is press-fit into the outer sleeve.

20. The powered fastener of claim 17, wherein the outer shell or the inner sleeve is coated with a surface coating to improve a sealing surface between the cylinder and the piston.
